(19) United States
(12) Patent Application Publication
(10) Pub. No.: US 2010/0064520 A1
(43) Pub. Date: Mar. 18, 2010

(54) MODULAR GROOMING TOOL WITH DUAL MOTORS

(76) Inventors: Sung K. Park, Chestnut Hill, MA (US); Douglas C. Dayton, Harvard, MA (US)

Correspondence Address: STRATEGIC PATENTS P.C.., C/O PORTFOLIOIP, P.O. BOX 52050, MINNEAPOLIS, MN, 55402, US

(21) Appl. No.: 12/556,645

(22) Filed: Sep. 10, 2009

Related U.S. Application Data
(63) Continuation-in-part of application No. 11/800,470, filed on May 4, 2007, now abandoned.
(60) Provisional application No. 61/121,365, filed on Dec. 10, 2008.
(60) Provisional application No. 60/798,349, filed on May 5, 2006.

(51) Int. Cl. B26B 19/00; B26B 19/28

(52) U.S. Cl. 30/29.5; 30/34.1; 30/42

(57) ABSTRACT

A modular hair grooming tool is disclosed. The system may include a hand-piece for holding the tool, a razor assembly coupled to a first end of the hand-piece such that the razor assembly is removable, and a nose/ear hair trimmer coupled to the first end of the hand-piece. The nose/ear hair trimmer may be configured to couple with the razor assembly to nest within the razor assembly while the razor assembly is coupled to the first end of the hand-piece. The system may further include a beard trimmer coupled to a second end of the hand-piece, and a protective cap removably coupled to the second end of the hand-piece and configured to cover the beard trimmer while coupled to the second end of the hand-piece.

### RELATED APPLICATIONS

This application claims the benefit of U.S. Provisional Application No. 61/121,365 filed Dec. 10, 2008. This application is also a continuation-in-part of U.S. Non-Provisional application Ser. No. 11/800,470 filed May 4, 2007, which claims the benefit of U.S. Provisional Application No. 60/798,349 filed on May 5, 2006.

Each of the foregoing applications is hereby incorporated by reference in its entirety.

### BACKGROUND

1. Field

The invention relates to a multi-function modular hair grooming tool.

2. Description of the Related Art

People may have multiple grooming tools in their homes, in their cars, at work, or carried with them for ongoing personal grooming purposes requiring the purchase, management and maintenance of sometimes redundant mechanisms. There remains a need for improved motor-driven grooming tools capable for a variety of grooming tasks and suitable for use in a variety of contexts.

### SUMMARY

A modular hair grooming tool is disclosed. The system may include a hand-piece for holding the tool, a razor assembly coupled to a first end of the hand-piece such that the razor assembly is removable, and a nose/ear hair trimmer coupled to the first end of the hand-piece. The nose/ear hair trimmer may be configured to couple with the razor assembly to nest within the razor assembly while the razor assembly is coupled to the first end of the hand-piece. The system may further include a beard trimmer coupled to a second end of the hand-piece, and a protective cap removably coupled to the second end of the hand-piece and configured to cover the beard trimmer while coupled to the second end of the hand-piece.

The system may be configured to be battery powered and may include a power switch disposed along a surface of the hand-piece. The hand-piece may further include one or more electric motors and appropriate gear trains. The electric motor may provide reciprocating motion to the beard trimmer and the electric motor and/or rotary motion to the first end of the hand-piece. The razor assembly may further include an eccentric weight connected to a flywheel. The razor may be configured to allow the user to couple the razor to the protective cap on the second end of the hand-piece.

The invention provides a modular approach to a suite of hair grooming tools, creating a universal range of interchangeable implements. Such implements may use one motor and drive system, or two motors and drive systems. The modular approach may achieve high efficacy across the range of implements and uses, and may create a more manageable system of hair grooming tools.

Various aspects of the invention may provide one or more of the following capabilities. A modular hair grooming tool may be provided that utilizes various interchangeable implements that perform a range of grooming functions. A motor powered grooming tool may also be provided. For example, the powered grooming tool may provide a reciprocating motion to one implement at one end of the tool and a vibrating motion or rotary motion to another implement at an opposite end of the tool. A portable, battery powered modular grooming tool may be provided. A modular grooming tool may be provided in which some of the grooming implements may be nested one inside the other. The modular grooming tool may apply a vibration to one or more of the implements, heads, or tools coupled thereto.

In an aspect of the invention, a method and system for a modular hair grooming tool includes a hand-piece for holding the tool, a razor assembly coupled to a first end of the hand-piece such that the razor assembly is removable, a nose/ear hair trimmer coupled to the first end of the hand-piece wherein the nose/ear hair trimmer is configured to couple with the razor assembly to nest within the razor assembly while the razor assembly is coupled to the first end of the hand-piece, and a beard trimmer coupled to a second end of the hand-piece. The method and system may further include a protective cap removably coupled to the second end of the hand-piece and configured to cover the beard trimmer while coupled to the second end of the hand-piece. In the method and system, the hand-piece includes an electric motor and appropriate transmission gear train to provide reciprocating motion to the beard trimmer. The electric motor may be configured to be battery powered and includes a power switch disposed along a surface of the hand-piece. The razor assembly may further include an eccentric weight connected to a flywheel. In the method and system, the hand-piece includes an electric motor configured to provide rotary motion to the first end of the hand-piece. The electric motor may be configured to be battery powered and include a power switch disposed along a surface of the hand-piece. The razor assembly may further include an eccentric weight connected to a flywheel. In the method and system, the razor may be configured to allow the user to couple the razor to the protective cap on the second end of the hand-piece.

In an aspect of the invention, a system for a modular hair grooming tool may include a hand-piece for holding the tool, a razor assembly coupled to a first end of the hand-piece such that the razor assembly is removable, a nose/ear hair trimmer coupled to the first end of the hand-piece, wherein the nose/ear hair trimmer is configured to couple with the razor assembly to nest within the razor assembly while the razor assembly is coupled to the first end of the hand-piece, a beard trimmer coupled to a second end of the hand-piece, and a protective cap removably coupled to the second end of the hand-piece and configured to cover the beard trimmer while coupled to the second end of the hand-piece, wherein the nose/ear hair trimmer is powered by a first motor and the beard trimmer is powered by a second motor. In the system, the first and second motors may be configured to be battery powered and actuated by at least one power switch disposed along a surface of the hand-piece. In the system, the first motor may include a transmission gear train that provides rotary motion to the first end of the hand-piece. In the system, the second motor may include a gear train that provides reciprocating motion to the second end of the hand-piece. In the system, the razor assembly may further include an eccentric weight connected to a flywheel. The razor assembly may be configured to allow the user to couple the razor to the protective cap on the second end of the hand-piece.

These and other capabilities of the invention, along with the invention itself, will be more fully understood after a review of the following figures, detailed description, and claims.

These and other systems, methods, objects, features, and advantages of the present invention will be apparent to those skilled in the art from the following detailed description of the preferred embodiment and the drawings.

All documents mentioned herein are hereby incorporated in their entirety by reference. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context.

### BRIEF DESCRIPTION OF THE FIGURES

The invention and the following detailed description of certain embodiments thereof may be understood by reference to the following figures:

FIG. 1 is an exploded perspective view of a multi-function modular hair grooming tool.

FIG. 2 is an exploded perspective view of the multi-function modular hair grooming tool shown in FIG. 1 including a beard trimmer.

FIG. 2A is an exploded perspective view of the multi-function modular hair grooming tool shown in FIGS. 1 and 2 including the beard trimmer and a nose/ear hair trimmer.

FIG. 3 is an exploded perspective view showing interior drive system components of the modular hair grooming tool shown in FIGS. 1, 2 and 2A.

FIG. 4 is an exploded perspective view which depicts a drive mechanism which connects the vibrating shaving head implement to the grooming tool.

FIGS. 5A & 5B depict exploded views of the grooming tool showing the internal drive components.

### DETAILED DESCRIPTION

The multi-function modular hair grooming tool is a portable, battery powered tool that combines a plurality of hair grooming implements on a single end or both ends of the tool through the use of a nesting configuration and the appropriate torque drive connections within the nested components.

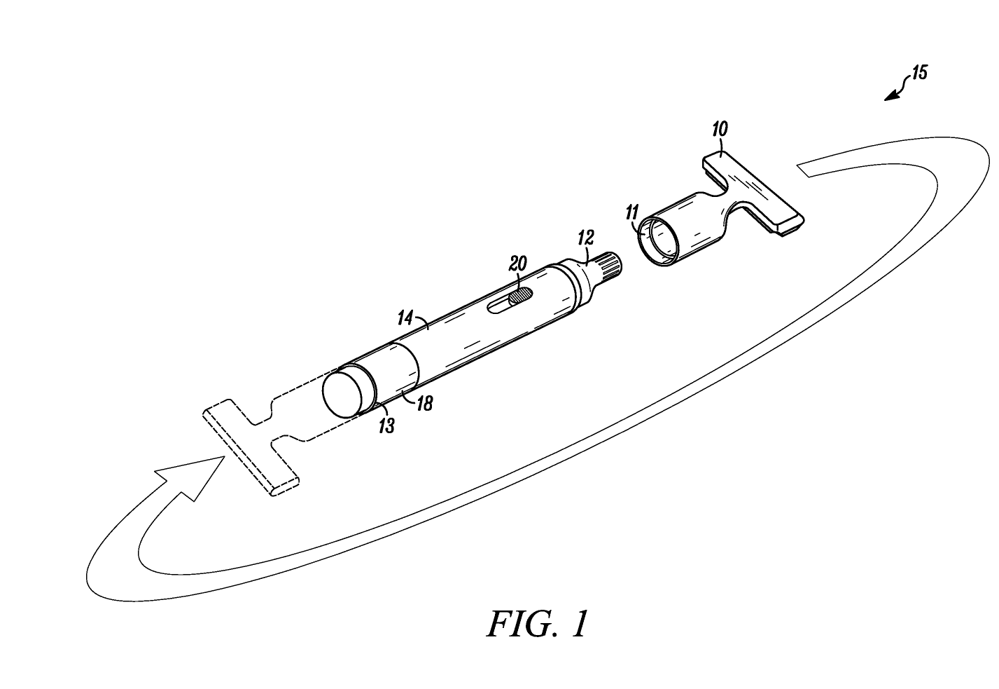

Referring to FIG. 1, an exemplary embodiment of a modular hair grooming tool 15 may include a hand-piece/body 14, a razor assembly 10, a nose/ear hair trimmer 12, a receiving feature 13, and a protective cap 18. The modular hair grooming tool 15 may be configured to power various interchangeable grooming implements. The modular hair grooming tool 15 may also be configured to allow the nose/ear hair trimmer 12 to nest inside of the razor assembly 10. The protective cap 18 may be configured to cover a beard trimmer, as described below. The hand-piece 14 may be configured to contain a power source, such as a battery, and a motor that may contain a transmission gear train. The transmission gear train may be configured to provide mechanical motion to both ends of the modular hair grooming tool 15.

The hand-piece 14 may include a power switch 20 disposed such that a portion is exposed along a surface of the body of the hand-piece 14 for actuation and is operatively connected to an internal switch and/or electrical component(s) that facilitate “ON/OFF” operation(s) or mode(s) and/or other functions of the modular hair grooming tool 15. The power switch 20 may be configured to select operation of the beard trimmer, as described below, the nose/ear hair trimmer 12, and/or the razor assembly 10, if attached. The power switch 20 may also be configured to activate both the beard trimmer, as described below, the nose/ear hair trimmer 12, and/or the razor assembly 10, if attached at the same time. In another aspect, one or more sensors may be used to detect a state of the tool 15 (e.g., whether a part is attached or a cap is on) and a circuit within the tool 15 may use the sensor input(s) to responsively select which grooming device is activated by the power switch 20.

The razor assembly 10 may include a conventional safety razor cartridge for a single-edge razor, double-edge razor, or other multi-edge razor, any of which may be replaceable within the razor assembly 10 and disposable. The razor assembly 10 may also or instead include an eccentric weighted cam, as described below that provides vibration to a shaving head of the razor assembly 10 when the razor assembly 10 is attached to a torque drive connection of the nose/ear hair trimmer 12. In this latter embodiment, the razor assembly 10 may vibrate to provide a vibrating shaving action. The razor assembly 10 may also or instead include an electric razor using e.g., a foil or rotary structure that mechanically cuts hair when powered by a motor.

The razor assembly 10 may be configured to fit over the nose/ear hair trimmer 12, while the razor assembly 10 is in an active position, e.g., vibrating, during use. A razor coupling 11 may be configured to be quickly detachable from the nose/ear hair trimmer 12 by any of various mechanisms including, but not limited to, a flexing interference fit, a bayonet style attachment, a quarter turn thread with detent, a spring loaded ball detent with a registration feature, a friction fit, or many other suitable mechanical interface. The razor assembly 10 may also be placed in a storage or non-vibratory position over the receiving feature 13 disposed along the opposing end of the modular hair grooming tool 15. The movement of the razor assembly 10 by a user from covering the nose/ear hair trimmer 12 to a storage position on the receiving feature 13 allows the user access to and the use of the nose/ear hair trimmer 12.

The nose/ear hair trimmer 12 may be configured and disposed to act in a manner consistent with a conventional nose/ear hair trimmer when the razor assembly 10 is removed from covering the nose/ear hair trimmer 12. The nose/ear hair trimmer 12 may utilize the rotary motion output of an electric motor contained within the hand-piece 14 to drive one or more cutting surfaces in a rotary motion, as discussed in greater detail below.

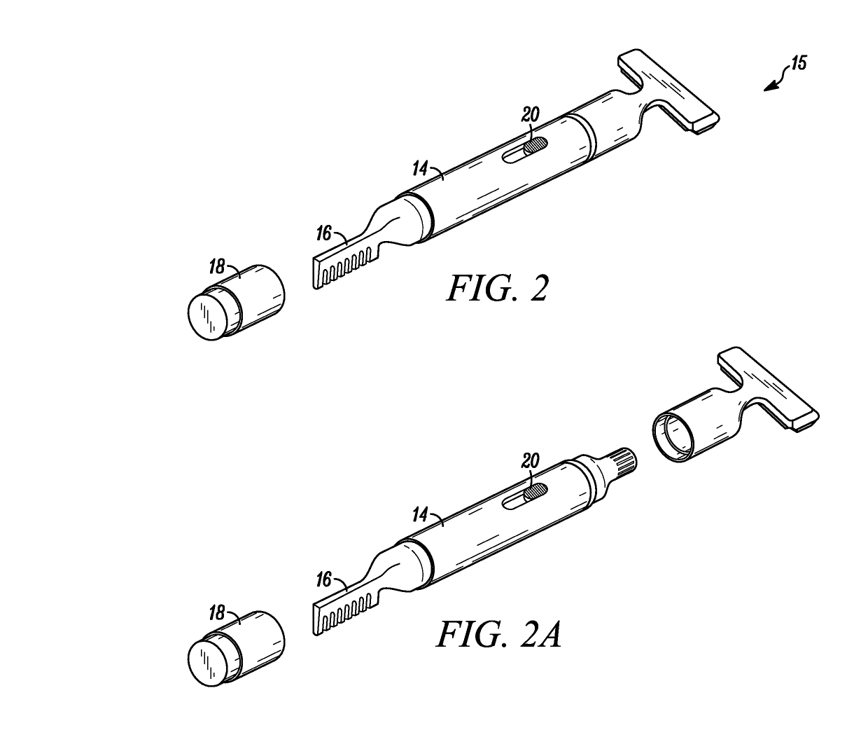

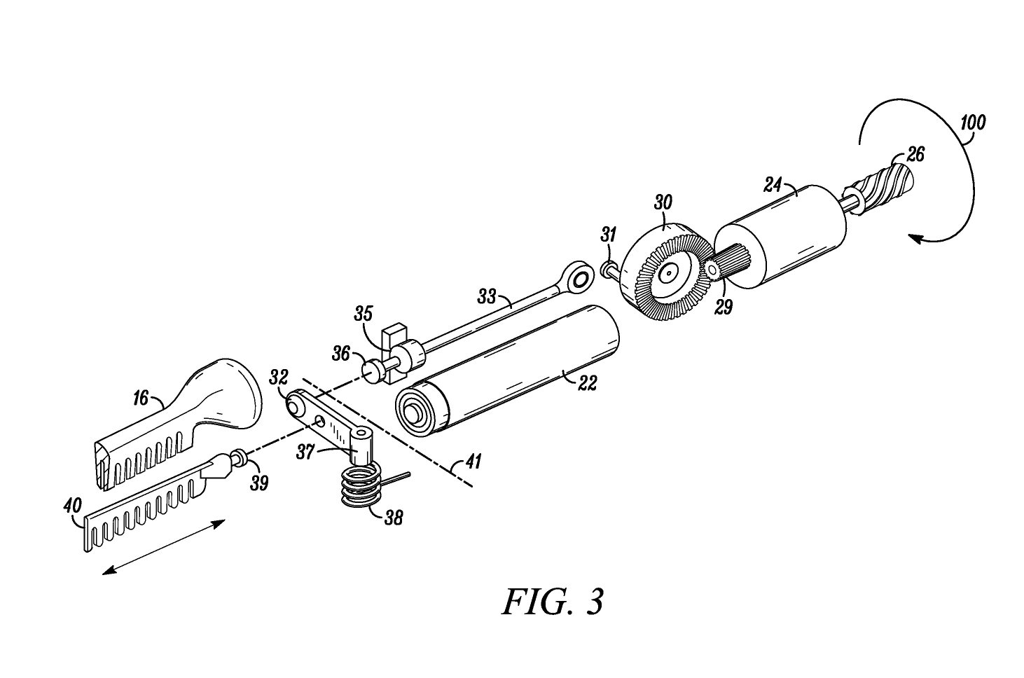

Referring to FIG. 2 with further reference to FIG. 1, the modular hair grooming tool 15 of FIG. 1 may further include a beard trimmer 16 such that the modular hair grooming tool 15 incorporates the hair removal functions of shaving, beard trimming and nose/ear hair removal. The razor assembly 10, as described above with respect to FIG. 1, is attached to the hand-piece 14 in a position that covers the nose/ear hair trimmer 12 and allows the nose/ear hair trimmer 12 to nest inside of the razor assembly 10. In one aspect, this includes enclosing the functional surface(s) of the nose/ear trimmer 12 within a cavity of the razor assembly 10 where the razor assembly 10 attaches to the hand-piece 14; however, it will be readily appreciate that numerous other physical arrangements are possible and may suitably be adapted to nest the nose/ear trimmer 12 inside the razor assembly 10 as described herein. The protective cap 18 may be removed to allow access to the beard trimmer 16.

Referring to FIG. 2A, both the protective cap 18 and the razor assembly 10 may be removed to expose and allow access to the beard trimmer 16 and the nose/ear hair trimmer 12, respectively. The power switch 20 is disposed such that at least a portion is exposed along a surface of the body of the hand-piece 14 and is operatively connected to an internal switch and/or electrical component(s) that facilitate “ON/OFF” operation(s) or mode(s) and/or other functions. The power switch 20 may be configured to select either operation of the beard trimmer 16 or the nose/ear hair trimmer 12, and the razor assembly 10, if attached. The power switch 20 may also be configured to activate both the beard trimmer 16 and the nose/ear hair trimmer 12, and the razor assembly 10, if attached at the same time. This may be accomplished, for example, with multiple positions for the power switch 20, or with multiple instances of the power switch 20, one to control each item on the modular hair grooming tool 15. In other embodiments, sensors or the like may be employed to detect which one(s) of the items is exposed for use, with output from the sensors used by a processor or other circuit(s) to selectively power the appropriate items when the power switch 20 is activated.

The beard trimmer 16 may be configured and disposed to act in a manner consistent with a conventional shuttle bar cutter for beards and facial hair. The hand-piece 14 may be configured to provide the required reciprocating motion to the beard trimmer 16. The beard trimmer 16 may be removable to provide access to a battery compartment or other internal spaces within the hand-piece such as for a retractable power/recharging cord, a socket or the like for such a cord, a brush to clean the beard trimmer 16 and other grooming tools, and so forth). The beard trimmer 16 may be driven with a connecting rod and a spring loaded paddle drive mechanism or other suitable electro-mechanical drive. In one embodiment, the rotary motion of a motor may be carried to the end of the device that includes the beard trimmer 16 with a non-removable right angle and reciprocating drive. In order to accommodate this arrangement, or for any other reason, battery access or other internal access as described above may be provided by a door in the side of the hand-piece 14. A protective cap 18 may be placed over the beard trimmer 16 to cover and to protect the beard trimmer 16 when not in use. The protective cap 18 may be removable and replaceable and may be configured to be quickly detachable using any of various techniques including, but not limited to, a snap feature, a friction fit, a bayonet style attachment, a quarter turn thread with detent, a spring loaded ball detent with a registration feature or any other suitable configuration.

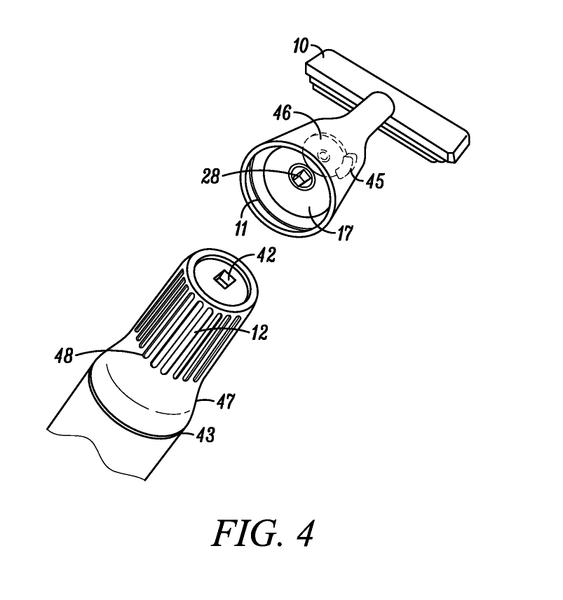

Referring to FIG. 3, and with further reference to FIGS.1-2A, the modular hair grooming tool 15 may include several internal drive components by which the modular hair grooming tool 15 provides rotary motion to the nose/ear hair trimmer 12 and simultaneously reciprocating motion to the beard trimmer 16. The internal drive components may include a battery power source 22, an electric motor 24, a cylindrical blade assembly 26, a gear 29, a ring gear 30, a crankshaft 31, a connecting rod 33, a spherical bearing 35, a reciprocating pommel 36, a receiving cup 32, a hinged paddle 37, a return spring 38, a flexible joint 39, and a shuttle bar trimmer blade 40.

The hand-piece 14 may contain the battery power source 22 that powers the motor 24. The battery power source 22 is shown as a single battery, but various numbers and sizes of batteries may be used, as well as replaceable and/or rechargeable batteries. The motor 24 may be any appropriately sized DC electric motor, AC electric motor, permanent magnet motor, brushless motor, stepper motor, or other appropriate electric motor or other electro-mechanical device for providing rotary motion.

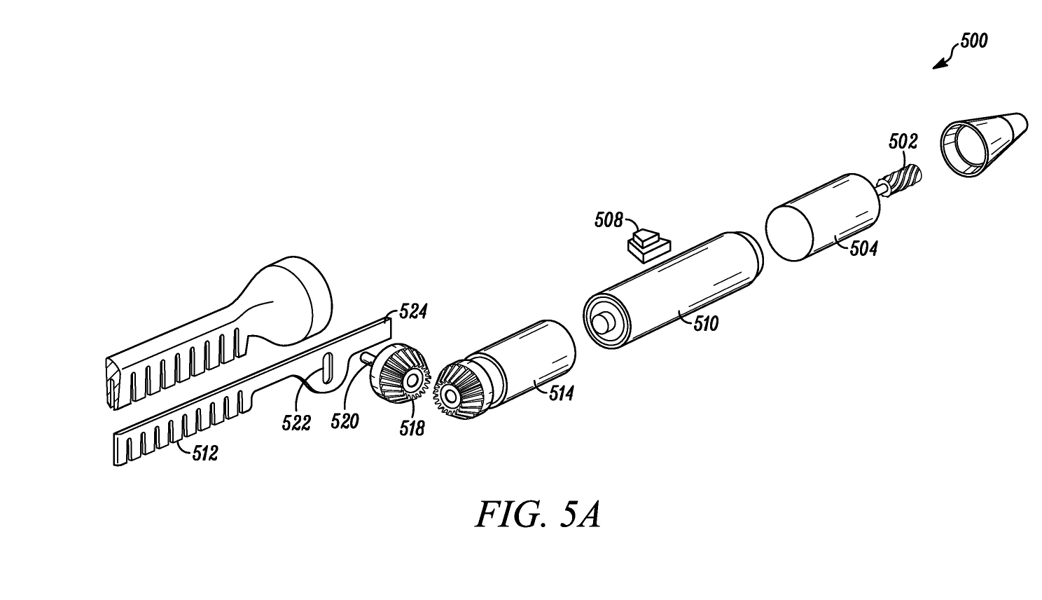

The cylindrical blade assembly 26 of the nose/ear hair trimmer 12 may be configured to rotate, as shown by arrow 100 in FIG. 3, inside a protective slotted housing 47 (shown in FIG. 4) and to trim the nose/ear hairs as the hairs enter a plurality of apertures 48 (shown in FIG. 4) in the protective slotted housing 47 by shearing contact to the hair between the cylindrical blade assembly 26 and plurality of apertures 48. The nose/ear hair trimmer 12 may be driven by an output shaft of the motor directly connected to the cylindrical blade assembly 26 inside the slotted housing 47. An end of the cylindrical blade assembly 26 may have a connection that allows a connection to a mating feature 28 in the razor assembly 10, as shown in FIG.4 and described below.

The gear 29 may be connected to an output shaft on the opposite end of the motor 24 from the cylindrical blade assembly 26. The gear 29 can be of various sizes and shapes as long as it is configured to work in conjunction with the ring gear 30 or other suitably adapted hardware to transform the rotary output motion of the motor 24 ninety degrees or perpendicular to the original output axis. It will be understood that similar operation may be achieved for axes with greater or lesser offsets (e.g., eighty degrees or other non-perpendicular orientations), with corresponding adaptations to the shape and orientation of the modular grooming tool 15 and/or items attached thereto, all without departing from the scope of this disclosure. The same effect can also or instead be achieved with a double bevel gear configuration.

The ring gear 30 may include a crankshaft 31 which may be configured and disposed to connect to the connecting rod 33 and to provide a reciprocating motion. Alternatively, a cam system or other similar means of creating reciprocating motion might be employed to the same purpose.

The connecting rod 33 may be configured and disposed to act in a manner consistent with a conventional power transmitting connecting rod. The connecting rod 33 as well as most of the drive components may be manufactured from plastic, metal, or other suitable materials, as well as any combination of the foregoing. The connecting rod 33 may be connected to the crankshaft 31 with a bearing. The connecting rod 33 may be constrained at a power delivery end of the connecting rod 33 by a spherical bearing 35 or similar fixture that accommodates the angular deviation of the reciprocating motion of the connecting rod 33. The power delivery end of the connecting rod 33 may terminate with a reciprocating pommel 36.

The reciprocating pommel 36 may be configured to transfer the drive motion through surface contact to the receiving cup 32 of the hinged paddle 37 that drives the beard trimmer 16. The reciprocating pommel 36 may be a part of the connecting rod 33 that is not connected to the receiving cup 32. Thus, the hinged paddle 37, which contains the receiving cup 32, may be easily separated from the connecting rod 33 for disassembly.

The shuttle bar trimmer blade 40 may be driven in a reciprocating motion by the hinged paddle 37. The hinged paddle 37 may include the receiving cup 32 for receiving a forward drive motion from the motor 24 and associated drive train. The hinged paddle 37 may also include a return spring 38 that provides a return drive motion for the hinged paddle 37. The shuttle bar trimmer blade 40 may be attached to the hinged paddle 37 by a flexible joint 39, or sliding ball joint or similar 3-degree of freedom connection that accommodates the lateral translation and flexing motion of the shuttle bar trimmer blade 40 as the blade is constrained by the beard trimmer housing and the hinged paddle 37 travels through its range of motion.

The beard trimmer 16 and the hinged paddle 37 may be removable along a partition line 41 to provide access to the battery 22. Alternatively, in some embodiments, the rotary motion of the motor 24 may be carried to the beard trimmer 16 end of the tool with a non-removable right angle and reciprocating drive-train and access to the battery 22 may be provided by a door in a side of the hand-piece 14.

Referring to FIG. 4, and with further reference to FIGS. 1 and 3, a vibratory drive mechanism of the razor assembly 10 may include a razor coupling 11, a mating feature 28, a torque drive connection 42, the nose/ear hair trimmer 12, a razor coupling receiving feature 43, an eccentric weight 45, a flywheel 46, a protective slotted housing 47, and a plurality of apertures 48.

The razor coupling 11 may be configured to mate with the razor coupling receiving feature 43 which allows the razor assembly 10 to securely attach over the nose/ear hair trimmer 12 onto the body of the hand-piece 14. This secure mechanical connection allows the nose/ear hair trimmer 12 to transmit torque to the razor assembly 10. The nose/ear hair trimmer 12 may have a torque drive connection 42 located at the end of the nose/ear hair trimmer 12 and may be recessed into the body of the nose/ear hair trimmer to allow normal use of the nose/ear hair trimmer 12. The torque drive connection 42 may have various design features for transmitting torque such as, but not limited to, a female socket with a flat side, a key, a pin, a square cross section, or an internal spline. The torque drive connection 42 may be recessed into the end of the cylindrical blade assembly 26 and configured to rotate, as shown by arrow 100 in FIG. 3. The cylindrical blade assembly 26 may rotate inside the protective slotted housing 47 to trim the nose/ear hairs as the hairs enter the plurality of apertures 48 in the protective slotted housing 47 by shearing contact to the hair between the cylindrical blade assembly 26 and plurality of apertures 48. The torque drive connection 42 may be configured to mate to the mating feature 28 on the razor assembly 10 while the razor assembly 10 is connected over the nose/ear hair trimmer 12.

The mating feature 28 on the razor assembly 10 may be configured to engage the torque drive connection 42 and to be connected to the eccentric weight 45 and flywheel 46 of the razor assembly 10.

The razor assembly 10 may include in an internal area 17, a flywheel 46 and an eccentric weight 45. The eccentric weight 45 may be connected to an outer edge of the flywheel 46. The flywheel 46 and the eccentric weight 45 may impart a controlled vibration to the razor assembly 10 when they are rotated. The flywheel 46 and the eccentric weight 45 may be rotated when they are coupled via the mating feature 28 and the torque drive connection 42 to the rotary motion of the nose/ear hair trimmer 12 and subsequently, the motor 24. Since the flywheel 46 and the eccentric weight 45 are contained within the razor assembly 10, the vibratory motion does not occur within the nose/ear hair trimmer 12 when the razor assembly 10 is not coupled thereto.

In general, as described above, the removal of a detachable tool or implement can reveal below it another ready-to-use tool or implement, which in some instances may itself be detachable to reveal yet a third grooming tool/head below.

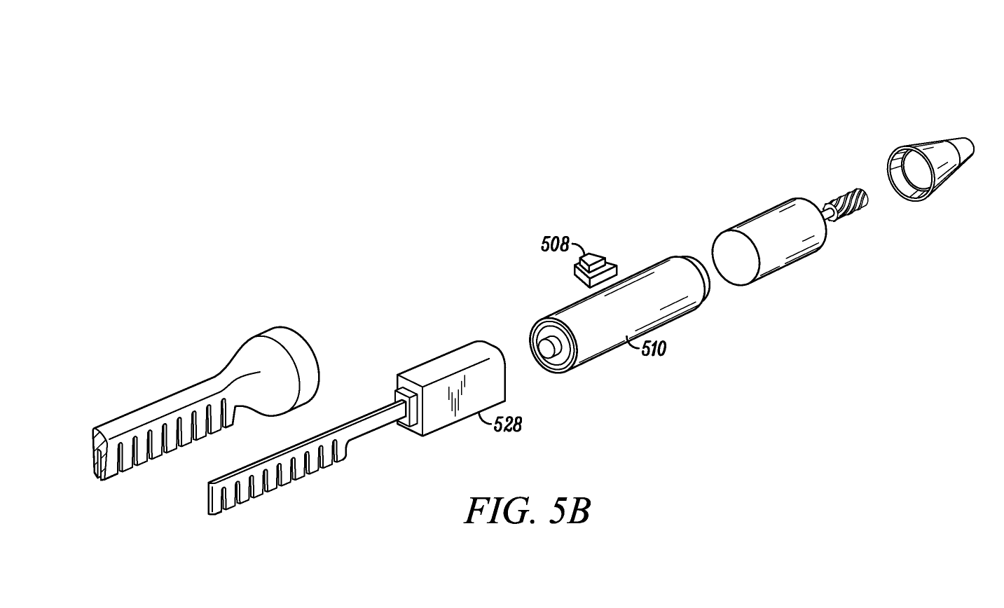

Referring to FIG. 5A, the double ended grooming tool 500 as described previously may be powered by a first electric motor 504 and a second electric motor 514 at opposing ends of the device, thus eliminating a complex mechanism to transfer power around a battery 510 power source. In an embodiment, rotational power may be furnished at the end of the grooming device where a rotating blade 502 resides, and where the vibrating razor blade may be attached. This rotational power may be provided by the first electric motor 504 that drives the rotating blade 502. The first electric motor 504 may be powered by the battery 510 and actuated selectively by a switch 508.

Reciprocating power may be furnished at the end of the grooming device where a reciprocating knife 512 (such as a beard/sideburn trimmer) resides. This reciprocating power may be provided by the second electric motor 514 that drives the reciprocating knife 512. In an embodiment, the second electric motor 514 may be powered by the battery 510 and actuated selectively by the switch 508. The rotational power of the motor shaft may be transferred along a perpendicular axis via miter gears 518 and a rotating pin 520 may drive the knife shaft 524 via a slot 522 it engages to create reciprocating motion of the knife shaft 524.

Referring to FIG. 5B, in an alternative embodiment, the double ended grooming tool 500 may be powered by two different types of electric motors at each end of the device. For example, reciprocating power may be furnished at the end of the grooming device where the reciprocating knife 512 resides. This reciprocating power may be provided by a solenoid motor 528 that drives the reciprocating knife 512. The solenoid motor 528 may be powered by the battery 510 and actuated selectively by a switch 508. The solenoid motor may achieve reciprocating motion by magnets and an electric field as with any solenoid and may shuttle the central knife shaft back and forth controlled by an electric circuit or a microprocessor.

It should be understood that the razor blade may be positioned on either end of the grooming tool, either attached to the end of the tool where the nose/ear hair trimmer resides or the end where the beard trimmer resides.

Having thus described at least one illustrative embodiment of the invention, various alterations, modifications and improvements will readily occur to those skilled in the art. Such alterations, modifications and improvements are intended to be within the scope and spirit of the invention. Accordingly, the foregoing description is by way of example only and is not intended as limiting. The invention's limit is defined only in the following claims and the equivalents thereto.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A system comprising:
a hand-piece for holding a modular hair grooming tool;
a razor assembly coupled to a first end of the hand-piece such that the razor assembly is removable;
a nose/ear hair trimmer coupled to the first end of the hand-piece,
wherein the nose/ear hair trimmer is configured to couple with the razor assembly to nest within the razor assembly while the razor assembly is coupled to the first end of the hand-piece;
a beard trimmer coupled to a second end of the hand-piece; and
a protective cap removably coupled to the second end of the hand-piece and configured to cover the beard trimmer while coupled to the second end of the hand-piece,
wherein the nose/ear hair trimmer is powered by a first electric motor and the beard trimmer is powered by a second electric motor.

2. The system of claim 1 wherein the first electric motor and the second electric motor are configured to be battery powered and actuated by at least one power switch disposed along a surface of the hand-piece.

3. The system of claim 1 wherein the first electric motor comprises a transmission gear train that provides rotary motion to the first end of the hand-piece.

4. The system of claim 1 wherein the second electric motor comprises a transmission gear train that provides reciprocating motion to the second end of the hand-piece.

5. The system of claim 1 wherein the razor assembly further comprises an eccentric weight connected to a flywheel.

6. The system of claim 5 wherein the razor assembly is configured to allow a user to couple the razor assembly to the protective cap on the second end of the hand-piece.
